(19) United States
(12) Patent Application Publication
(10) Pub. No.: US 2015/0124321 A1
(43) Pub. Date: May 7, 2015

(54) DISPLAY APPARATUS, METHOD FOR CONTROLLING DISPLAY APPARATUS, AND PROGRAM

(71) Applicant: CANON KABUSHIKI KAISHA, Tokyo (JP)

(72) Inventors: Yoshiki Iwakiri, Ebina-shi (JP); Tomoyuki Ohno, Zama-shi (JP); Daisuke Takayanagi, Kawasaki-shi (JP); Tomoki Kuroda, Fujisawa-shi (JP)

(21) Appl. No.: 14/531,090

(22) Filed: Nov. 3, 2014

(30) Foreign Application Priority Data
Nov. 6, 2013 (JP) 2013-230437
Nov. 19, 2013 (JP) 2013-239112

(51) Int. Cl. G02B 7/00; G02B 27/64

(52) U.S. Cl. CPC G02B 7/005; G02B 27/646
USPC 359/554

(57) ABSTRACT

A display apparatus comprises a display panel; a vibration element configured to vibrate the display panel; a detection unit configured to detect movement of the display apparatus or turn of the display panel; and a correction unit configured to vibrate the vibration element in a case where the detection unit detects the movement of the display apparatus or the turn of the display panel.

### BACKGROUND OF THE INVENTION

1. Field of the Invention

The present invention relates to a display apparatus with a function to perform a correction operation on a panel.

2. Description of the Related Art

In recent years, there have been demands for display apparatuses such as liquid crystal displays and organic electro luminescence (EL) displays to achieve high color reproducibility and uniformity. Thus, calibration has been performed to maintain constant image quality.

Liquid crystal displays and organic EL displays use an optical element such as a liquid crystal panel, an organic EL panel, a glass substrate, or a polarizer. These optical elements may be warped or deflected as a result of physical stress caused by the own weight of the optical element as shown in FIG. 13.

Furthermore, possible burrs during manufacturing may cause a frictional force to be exerted on a portion depicted by reference numeral 1 in FIG. 13 (a contact portion between a cut surface of an optical element and a fixing unit). As a result, a portion depicted by reference numeral 2 (a contact portion between a surface of the optical element and the fixing unit) remains warped or deflected, leading to an optical change. For example, in the example in FIG. 13, display unevenness may occur in a segment depicted by reference numeral 3, degrading color reproducibility and uniformity.

To solve this problem, a technique has been proposed in which a vibration element is provided inside a display to vibrate the optical element to eliminate warpage or deflection. For example, as depicted in FIG. 14, the vibration element adjacent to the fixing unit is vibrated to exert a reaction force on a portion depicted by reference numeral 4. As a result, the warpage or deflection in the optical element can be reduced to correct the display unevenness.

For example, Japanese Patent No. 4,282,226 describes, as a mechanism similar to the display with the vibration element, a camera that restores image quality by vibrating a built-in optical element.

### SUMMARY OF THE INVENTION

The display unevenness in the display panel can be corrected by applying the technique described in Japanese Patent No. 4,282,226. However, the optical element in the camera is vibrated by a user's operation, and thus, the correction is not always performed at the optimum timing.

When the display apparatus is used, the stress on the internal optical element varies in many cases, and performing a correction operation on the panel in each case is a burden on the user. Furthermore, forgetting to perform the correction operation results in the display unevenness remaining on a screen.

With these problems of the conventional technique in view, it is an object of the present invention to provide a technique for determining whether or not a correction operation needs to be performed on a display panel of a display apparatus to allow the correction operation to be automatically performed on the panel.

The present invention in its one aspect provides a display apparatus comprises a display panel; a vibration element configured to vibrate the display panel; a detection unit configured to detect movement of the display apparatus or turn of the display panel; and a correction unit configured to vibrate the vibration element in a case where the detection unit detects the movement of the display apparatus or the turn of the display panel.

The present invention in its another aspect provides a method for controlling a display apparatus including a display panel, a vibration element configured to vibrate the display panel, and a detection unit configured to detect movement of the display apparatus or turn of the display panel, the method comprises a determination step of determining whether the display apparatus has been moved or the display panel has been turned based on an output from the detection unit; and a correction step of vibrating the vibration element in a case where the display apparatus is determined to have been moved or the display panel is determined to have been turned.

The present invention in its another aspect provides a display apparatus capable of performing calibration, comprises a plate-like optical element; a vibration element; and a control unit configured to vibrate the vibration element to vibrate the optical element in a case where the calibration is performed.

The present invention in its another aspect provides a method for controlling a display apparatus including a plate-like optical element and a vibration element, the method comprises an execution step of calibrating the display apparatus; and a control step of vibrating the vibration element to vibrate the optical element in a case where the calibration is performed.

The present invention can provide a display apparatus that detects whether or not a correction operation needs to be performed on a display panel to allow the correction operation to be automatically performed on the panel.

Further features of the present invention will become apparent from the following description of exemplary embodiments with reference to the attached drawings.

### BRIEF DESCRIPTION OF THE DRAWINGS

FIG. 1 is a diagram depicting a configuration of a display apparatus according to a first embodiment;

FIG. 2 is a diagram of a flow of a process executed when the display apparatus according to the first embodiment is powered off;

FIG. 3 is a diagram illustrating a moving average of a sensor value;

FIG. 4 is a diagram of a flow of a process executed when the display apparatus according to the first embodiment is powered on;

FIG. 5 is a diagram depicting a configuration of a display apparatus according to a second embodiment;

FIG. 6 is a diagram depicting an example of a vibration amount conversion table;

FIG. 7 is a diagram of a flow of a process executed when the display apparatus according to the second embodiment is powered off;

FIG. 8 is a diagram of a flow of a process executed when the display apparatus according to the second embodiment is powered on;

FIG. 9 is a diagram depicting a configuration of a display apparatus according to a third embodiment;

FIG. 10 is a diagram of a flow of a process executed by the display apparatus according to the third embodiment;

FIG. 11 is a diagram of a flow of a process executed by a display apparatus according to a fourth embodiment;

FIG. 12 is a diagram of a flow of a process executed by a display apparatus according to a fifth embodiment;

FIG. 13 is a diagram illustrating warpage of an optical element; and

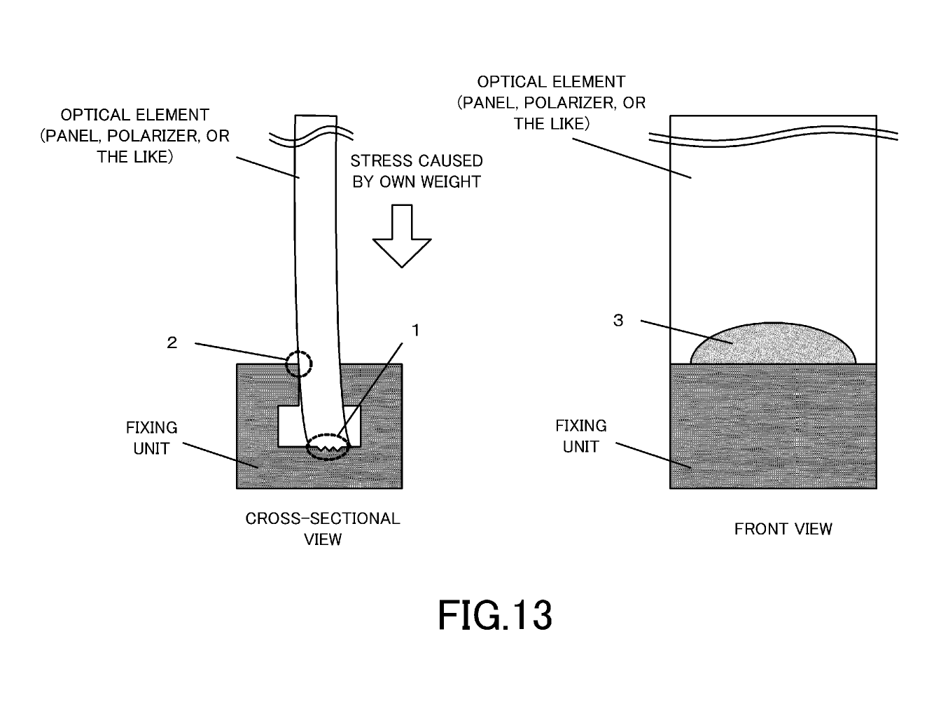

FIG. 14 is a diagram illustrating warpage correction for the optical element using vibration.

### DESCRIPTION OF THE EMBODIMENTS

Embodiments of the present invention will be described below in detail with reference to the drawings.

### First Embodiment

A display apparatus according to a first embodiment has a correction function for a liquid crystal panel (hereinafter referred to as a display panel) and performs a correction operation on the display panel when the stress on the display panel changes. Specifically, while power of the display apparatus is off, a sensor or the like is used for monitoring to determine whether or not the display apparatus has been moved or the display panel has been turned. When the movement or turn is detected, a correction operation is performed on the display panel at a timing when the display apparatus is powered on. The “correction” as used herein refers to elimination of warpage or deflection of the display panel performed by vibrating a vibration element.

The movement of the display apparatus includes, for example, a change in installation place. The turn of the display panel includes vertical or horizontal turn of the display.

Furthermore, the display apparatus according to the first embodiment may be an apparatus including a stand and a display and in which only the display is turned, or an integral apparatus such as a tablet. When the apparatus is integral, the turn of the display panel includes a change in vertical or horizontal position.

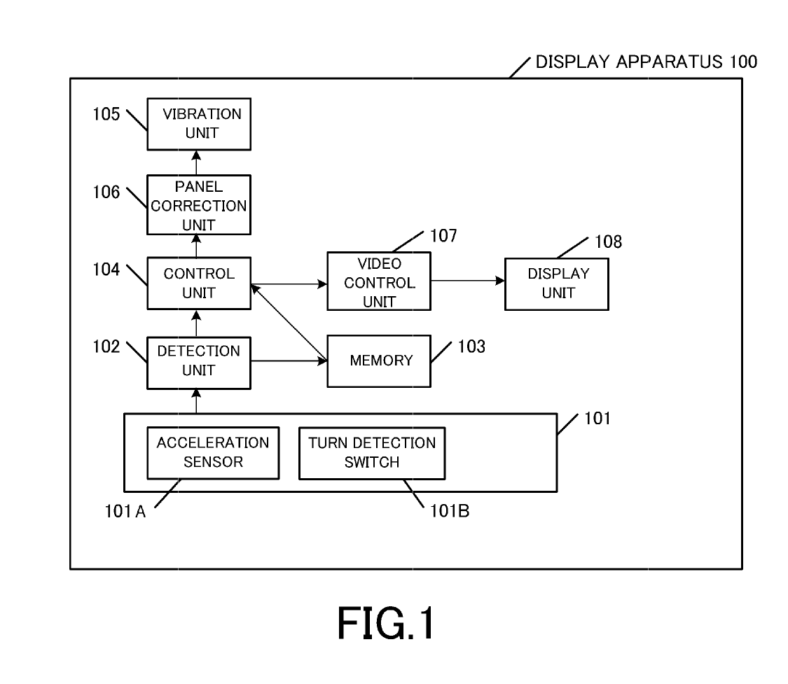

First, a configuration of the display apparatus according to the first embodiment will be described with reference to the FIG. 1. The display apparatus according to the first embodiment has a sensor 101, a detection unit 102, a memory 103, a control unit 104, a vibration unit 105, a panel correction unit 106, a video control unit 107, and a display unit 108.

The units providing the display apparatus according to the first embodiment will be described.

The sensor 101 is a sensor (detection unit) that detects movement of the display apparatus and turn of the display panel. The sensor 101 may be any sensor provided that an output value from the sensor 101 changes when the display apparatus is moved or the display panel is turned. According to the first embodiment, the sensor 101 includes a uniaxial acceleration sensor 101A that outputs a positive value when the apparatus is accelerated in a direction parallel to the direction of gravitational force and a turn detection switch 101B that detects the state of vertical or horizontal turn of the display. However, the sensor 101 may include only either the acceleration sensor 101A or the turn detection switch 101B.

A value output by the sensor 101 (hereinafter referred to as a sensor value) is input to the detection unit 102.

The detection unit 102 is a unit that acquires the sensor value from the sensor 101 to determine whether or not the display apparatus has been moved or the display panel has been turned on the basis of the sensor value. Furthermore, the detection unit 102 is a unit that, upon determining that the display apparatus has been moved or the display panel has been turned, generates information indicating whether or not a correction operation needs to be performed on the display panel. A process for determining whether or not the display apparatus has been moved or the display panel has been turned will be described below. The information indicating whether or not the correction operation needs to be performed on the display panel will hereinafter be referred to as a correction flag.

Upon detecting movement of the display apparatus or turn of the display panel, the detection unit 102 allows the correction flag generated based on the sensor value to be stored in the memory 103 described below.

In the present embodiment, an acceleration sensor is used as the sensor 101A. However, movement of the apparatus may be detected using a switch that detects depression or contact. For example, a contact sensor or a switch that detects grounding may be provided on a bottom surface of the stand of the display apparatus to allow the detection unit 102 to detect movement of the display apparatus.

The memory 103 is a nonvolatile memory that stores the correction flag. The memory 103 receives the correction flag from the detection unit 102 for temporary storage and then provides the correction flag to the control unit 104.

The control unit 104 is a unit that controls a display apparatus 100 according to the first embodiment. Specifically, the control unit 104 performs control to acquire a video signal from outside and output the video signal to the display panel (not depicted in the drawings) through a controller, and control to perform the correction operation on the display panel via the panel correction unit 106 described below. A panel correction process will be described below.

The vibration unit 105 is a unit that vibrates the display panel and is typically a motor (that is, a vibrator) including a weight which is attached to a rotating shaft of the motor and for which the center of gravity is shifted. When a voltage is applied to the vibration unit 105, the vibration unit 105 rotates and can generate vibration. The vibration unit 105 is preferably arranged near the display panel, particularly near an area where warpage or defection is likely to occur.

The panel correction unit 106 is a unit which acquires an instruction to perform panel correction from the control unit 104 and which performs the correction operation on the display panel by controlling the voltage applied to the vibration unit 105. The correction operation for the display panel as used herein refers to an operation of vibrating the vibration unit 105 to vibrate a part of the display panel.

The video control unit 107 is a unit that executes processes needed to display a video on an input video signal. Specifically, an enlargement and reduction process, a brightness adjustment process, a color process, and the like are executed on the video signal acquired from the control unit 104.

The display unit 108 is a controller configured to output the video signal processed by the video control unit 107 to the display panel.

The sensor 101, the detection unit 102, and the memory 103 operate even while the display apparatus is not supplied with external power. The power needed for this purpose may be supplied by, for example, a battery (not depicted in the drawings) provided in the display apparatus 100.

Now, a process will be described in which the display apparatus 100 detects movement of the display apparatus or turn of the display panel to perform the correction operation on the panel. The process executed by the display apparatus 100 is classified into two types: a process executed while the apparatus is powered off and a process executed while the apparatus is powered on.

The state in which the “apparatus is powered off” may be a state in which any segment other than the display panel is energized provided that the display panel is not energized. For example, a state is possible in which the display panel is not energized, while the control unit is energized (standby state) or in which neither the display panel nor the control unit is energized. Alternatively, a state is possible in which the apparatus is supplied with no external power.

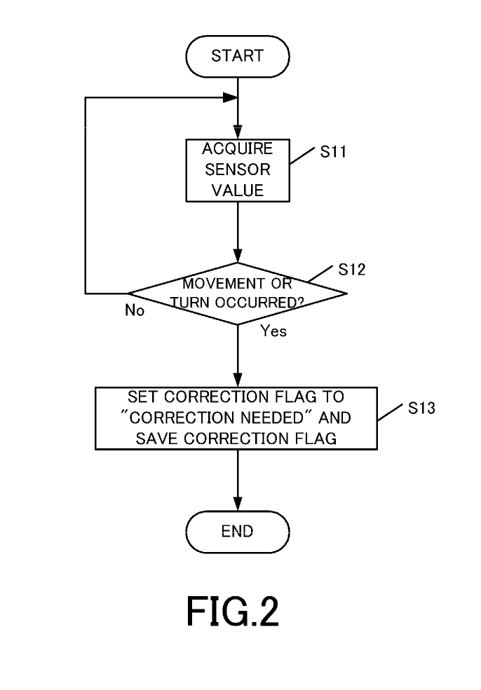

First, a process sequence executed when the apparatus is powered off will be described with reference to FIG. 2. The process involves monitoring movement of the apparatus or turn of the display panel to record, in the memory 103, information indicating whether or not the correction operation needs to be performed on the display panel.

The process depicted in FIG. 2 is, for example, started when the energization to the display panel is stopped (that is, brought into a standby state) and executed without interruption even when the external power supply is lost. If the process is in execution when the display panel is energized, the process is interrupted and ended.

First, in step S11, the detection unit 102 acquires the sensor values from the acceleration sensor 101A and the turn detection switch 101B. Specifically, the detection unit 102 acquires the sensor value representing the acceleration from the acceleration sensor 101A and acquires the sensor value representing the vertical and horizontal turn state of the display panel from the turn detection switch 101B.

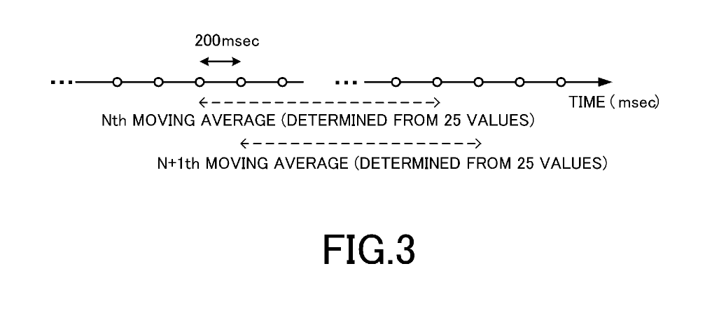

Furthermore, in the first embodiment, a process of calculating a moving average is executed on the sensor value acquired from the acceleration sensor 101A. Specifically, 25 sensor values are acquired from the acceleration sensor 101A at intervals of 200 milliseconds, and the moving average is determined as depicted in FIG. 3. This allows deflection of the sensor value to be absorbed.

Then, the difference between the Nth moving average and the N+1th moving average is calculated. The intervals of the acquisition of the sensor values form the acceleration sensor 101A and the number of sensor values acquired may have any values. The calculated moving average is hereinafter referred to as the acceleration sensor value.

In step S12, the detection unit 102 determines whether or not the display apparatus has been moved or turned.

First, based on the sensor value acquired from the turn detection switch 101B, the detection unit 102 determines whether or not the turn state of the display has changed compared to the last turn state to determine “tuned” or “not turned”. The turn state is temporarily stored and used for the subsequent determinations.

The detection unit 102 then determines whether or not the absolute value of the amount of change in acceleration sensor value exceeds a threshold. The threshold for the determination is assumed to be pre-stored in the detection unit 102.

As described above, the acceleration sensor 101A detects the acceleration acting in the direction of gravitational force as a positive value. Thus, when the display apparatus has not been moved, the output acceleration sensor value is 9.8 m/sec² (acceleration of gravity). In this regard, the description assumes that the threshold is 0.1 m/sec².

For example, when the Nth acceleration sensor value is 9.8 m/sec² and the N+1th acceleration sensor value is 9.9 m/sec², the detection unit 102 determines the state to be “moved”. Furthermore, when the N+1th acceleration sensor value is 9.8 m/sec², the detection unit 102 determines the state to be “not moved”.

Upon determining the state to be “moved” or “turned”, the detection unit 102, in step S13, generates a correction flag with a value representing “correction needed” and stores the correction flag in the memory 103. If the correction flag is already stored in the memory 103, the flag is overwritten with the latest value. An initial value for the correction flag is “correction unneeded”.

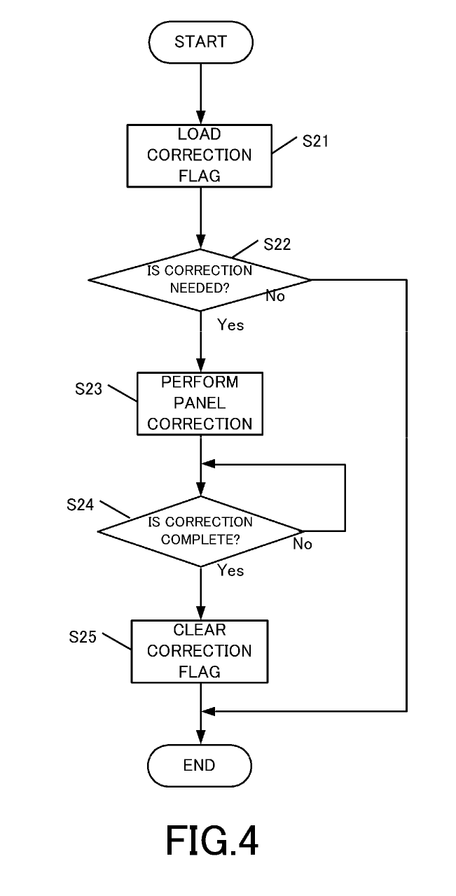

Now, a process sequence executed when the apparatus is powered on will be described with reference to FIG. 4.

The process involves executing a correction process on the display panel based on information recorded in the memory 103. The process depicted in FIG. 4 is started when the display panel is energized.

First, the control unit 104 acquires the correction flag from the memory 103 (step S21).

Then, in step S22, the control unit 104 references the value of the acquired correction flag, and when the value represents “correction needed”, shifts to step S23. When the value represents “correction unneeded”, the control unit 104 skips the process for the correction operation for the display panel to end the process.

In step S23, the control unit 104 transmits an instruction to perform the correction operation on the panel to the panel correction unit 106. The panel correction unit 106 operates the vibration unit 105 to perform the correction operation on the display panel.

In step S24, the control unit 104 waits for a notification indicating that the correction has ended from the panel correction unit 106. Upon receiving the notification, the process shifts to step S25.

In step S25, the control unit 104 clears the correction flag, that is, sets the value representing “correction unneeded” for the correction flag and writes the correction flag to the memory 103.

When the process in FIG. 4 is complete, the control unit 104 starts outputting video signals to the video control unit 107, and the video control unit 107 starts processing videos. The processed videos are transmitted to the display unit 108, which sequentially outputs the videos to the display panel.

As described above, the display apparatus according to the first embodiment can detect movement of the display apparatus or turn of the display panel to allow the correction operation to be automatically performed on the display panel. This eliminates the need for the user to perform the correction operation on the panel, enabling a reduction in the burden on the user. Furthermore, the image quality of the display panel can be constantly kept optimum.

### Variation of the First Embodiment

In the first embodiment, the uniaxial acceleration sensor is used as the acceleration sensor 101A. However, a triaxial acceleration sensor may be used to further detect accelerations acting in directions other than the direction of gravitational force. In this case, the state may be determined to be “moved” when the acceleration acting on any axis exceeds a threshold or when an acceleration resulting from synthesis of three accelerations exceeds a threshold.

Furthermore, the sensor 101 may be a sensor that can detect angular velocity or inclination. Thus, various sensors may be used as the sensor 101.

In the first embodiment, the movement of the display apparatus 100 is monitored while the display panel is not energized, and the correction operation is performed on the display panel at the timing when the display panel is energized. However, each process may be executed at a different timing. For example, the process in FIG. 2 may be started at a timing when a main power supply to the display apparatus is turned off or the process in FIG. 4 may be started at a timing when the main power supply to the display apparatus is turned on.

Furthermore, the movement and turn may be monitored while the display panel is energized. For example, in a display apparatus that allows the display to be turned while the apparatus remains powered on, the correction operation may be performed on the display panel immediately after turn is detected. In such a case, the memory 103 may be omitted.

Thus, the processes depicted in FIG. 2 and FIG. 4 may be executed at any timings provided that movement of the display apparatus or turn of the display panel can be detected and that the correction operation can be performed on the display panel at an appropriate timing.

Furthermore, the correction operation on the display panel may be started at a timing when the acceleration or inclination is stable or when the acceleration or inclination is unstable. For example, when turn of the screen is detected, the correction operation may be started during the turn. This enables a reduction in the user's wait time.

Furthermore, the correction operation on the display panel may be started automatically or after the need for the correction operation is presented to the user.

### Second Embodiment

A second embodiment is an embodiment in which the amount of vibration for a correction operation on a panel is controlled based on acquired sensor values. In the second embodiment, turn of the display panel is not detected, but only movement of a display apparatus is detected.

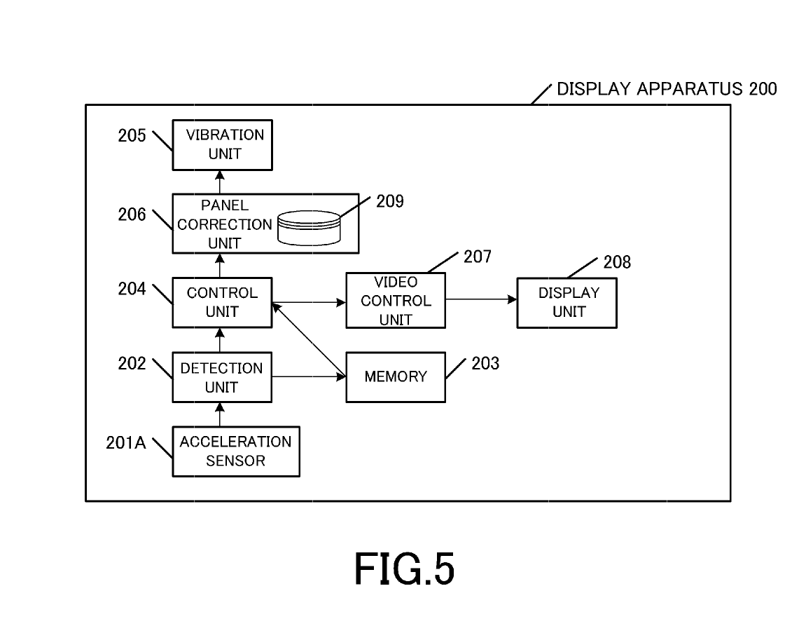

A configuration of a display apparatus 200 according to the second embodiment will be described with reference to FIG. 5 that is a diagram of the display apparatus according to the second embodiment. Components of the second embodiment which are different from the corresponding components of the first embodiment only in the hundreds place of the reference numeral basically provide the same functions as the corresponding functions according to the first embodiment. Thus, the description of these components is omitted except for differences.

In the second embodiment, only an acceleration sensor 201A is used to detect movement of the display apparatus. Furthermore, in the second embodiment, a panel correction unit 206 stores a vibration amount conversion table 209 that is a table configured to allow the amount of vibration to be determined. The vibration amount conversion table 209 is a table in which the amount of change in the sensor value acquired by a detection unit 202 is recorded in association with the amount of vibration for the correction operation on the display panel. The table is previously created and stored based on the results of adjustments.

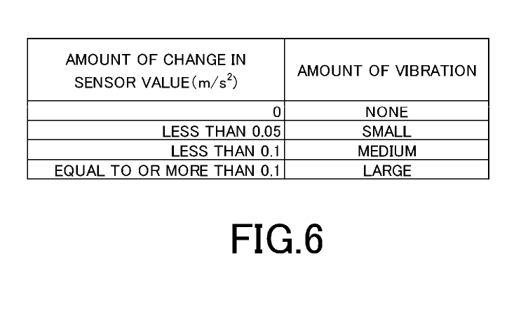

FIG. 6 depicts an example of the vibration amount conversion table. A large amount of change in sensor value is expected to indicate a high stress on the display panel, that is, a large amount of warpage of the panel, leading to significant display unevenness. Thus, the display apparatus is configured to increase the amount of vibration consistently with the amount of change in sensor value.

Furthermore, a vibration unit 205 according to the second embodiment is a vibrator that allows the amount of vibration to be adjusted by an applied voltage.

Additionally, in the second embodiment, the detection unit 202 allows the memory 203 to store the “amount of change in sensor value” in addition to the “correction flag”. The amount of change in sensor value is the amount of change in the value of an acceleration sensor when the detection unit 202 determines a movement state to be “moved”. That is, the amount of change in sensor value is a value representing the magnitude of a change in the acceleration acting on the apparatus.

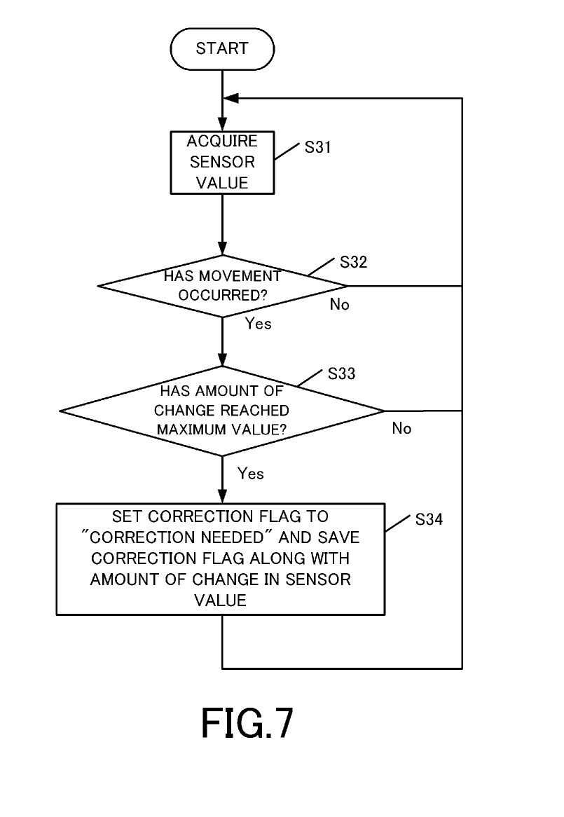

FIG. 7 shows a process sequence executed when the apparatus is powered off according to the second embodiment.

The process depicted in FIG. 7 is started when the energization to the display panel is stopped, and is interrupted and ended when the display panel is energized, as is the case with the first embodiment.

Processes in steps S31 and S32 are similar to the processes in steps S11 and S12 according to the first embodiment except that no turn detection switch is used in steps S31 and S32. Thus, description of steps S31 and S32 is omitted.

In step S33, the detection unit 202 determines whether or not the maximum value of the amount of change in acceleration sensor value has been updated. The maximum value is 0 m/sec² immediately after power-off. When the maximum value of the amount of change in acceleration sensor value is updated, the process shifts to step S34. Otherwise, the process shifts to step S31.

In step S34, the detection unit 202 sets a value representing “connection needed” for a correction flag and stores the correction flag in the memory 203. The acquired amount of change in acceleration sensor value is set as the amount of change in sensor value and stored in the memory 203.

As is the case with the first embodiment, the process in FIG. 7 is started when the energization to the display panel is stopped. However, the second embodiment is different from the first embodiment in that, in the second embodiment, the process is repeated after writing is performed on the memory 203. That is, each time the maximum value of the amount of change in acceleration sensor value is updated, the amount of change in sensor value stored in the memory 203 is overwritten and updated.

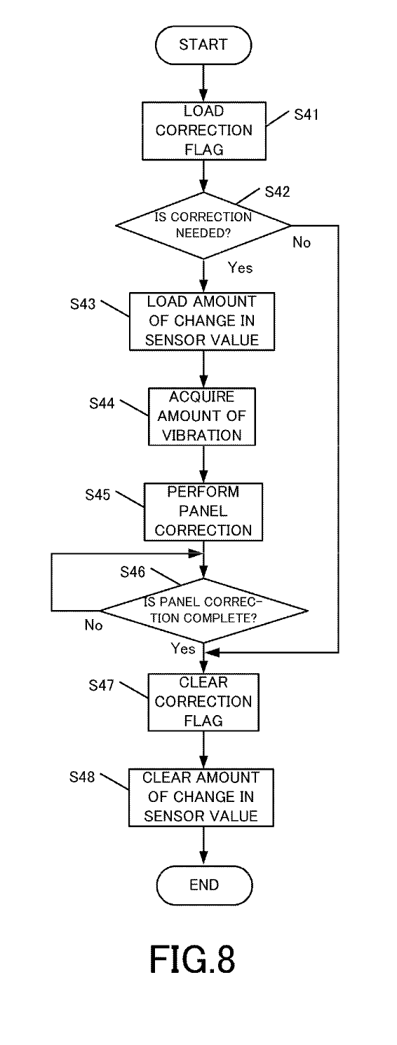

FIG. 8 depicts a process sequence executed when the apparatus is powered on according to the second embodiment.

The process depicted in FIG. 8 is started when the display panel is energized as is the case with the first embodiment.

Processes in steps S41 and S42 are similar to the processes in steps S21 and S22 according to the first embodiment. Thus, description of steps S41 and S42 is omitted.

In step S43, the control unit 204 acquires the amount of change in sensor value from the memory 203. The correction flag and amount of change in sensor value acquired are transmitted to the panel correction unit 206.

In step S44, the panel correction unit 206 references the vibration amount conversion table 209 to determine the amount of vibration. For example, in the example in FIG. 6, the amount of vibration is small when the amount of change in sensor value acquired is 0.01 m/sec², is medium when the amount of change in sensor value acquired is 0.06 m/sec², and is large when the amount of change in sensor value acquired is 0.2 m/sec².

Then, in step S45, the panel correction unit 206 applies a voltage corresponding to the determined amount of vibration to the vibration unit 205 to perform a correction operation on the display panel. Processes in steps S46 and S47 are similar to the processes in steps S24 and S25 according to the first embodiment. Thus, description of steps S46 and S47 is omitted.

In step S48, the control unit 204 clears the amount of change in sensor value, that is, sets the amount of change in sensor value to 0 m/sec² and writes the value to the memory 203.

When the process in FIG. 8 is complete, the control unit 204 starts outputting video signals to the video control unit 207, and the video control unit 207 starts processing videos. The processed videos are transmitted to the display unit 208, which sequentially outputs the videos to the display panel.

As described above, in the second embodiment, the magnitude of vibration is adjusted in accordance with the amount of change in sensor value. Thus, panel correction can be performed based on the intensity of vibration corresponding to the amount of warpage of the display panel. The image quality of the display panel can be kept optimum.

### Third Embodiment

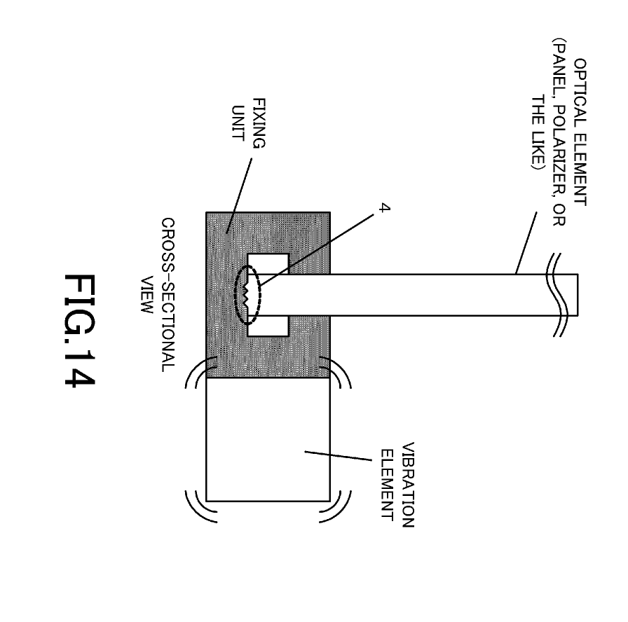

A display apparatus and a method for controlling the display apparatus according to a third embodiment of the present invention will be described below. The display apparatus according to the third embodiment can perform calibration. As depicted in FIG. 14, the display apparatus according to the third embodiment has a plate-like optical element and a vibration element. The optical element is a display panel (a liquid crystal panel, an organic EL panel, a plasma display panel, or the like) a glass substrate, and a polarizer. In the third embodiment, an example will be described in which the optical element is a display panel. In the third embodiment, an example will be described in which a vibration process is executed before the calibration is started. The vibration process is a process of vibrating the vibration element to vibrate the optical element. Executing the vibration process enables a temporary reduction in deformation of the optical element (caused by the own weight of the optical element) and a reduction in display unevenness.

FIG. 14 depicts an example in which the vibration element indirectly vibrates the optical element. Specifically, FIG. 14 depicts an example in which vibration of the vibration element is transmitted to the optical element via a fixing unit (which fixes the optical element), whereby the optical element is vibrated. However, the configuration of the present invention is not limited. For example, the vibration element may be provided on the optical element so as to directly vibrate the optical element. The vibration element may be provided in any manner as long as the optical element is vibrated by vibration of the vibration element.

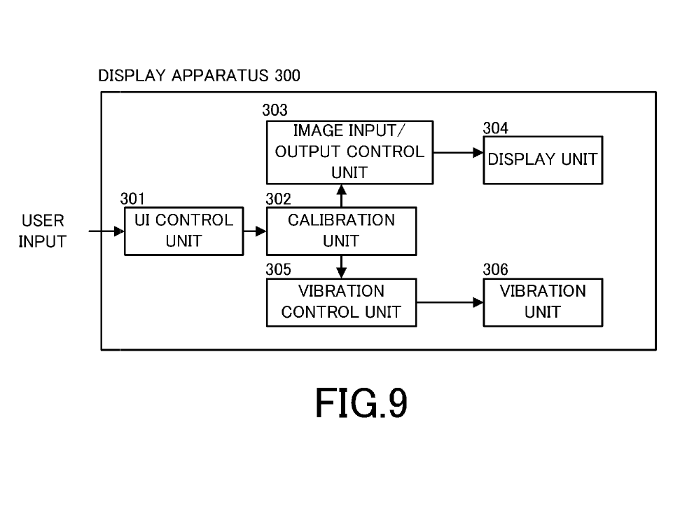

A functional configuration of the display apparatus according to the third embodiment will be described using a block diagram depicted in FIG. 9.

As depicted in FIG. 9, a display apparatus 300 according to the third embodiment has, for example, a UI control unit 301, a calibration unit 302, a vibration unit 303, a vibration control unit 304, an image input/output control unit 305, and a display unit 306.

The UI control unit 301 accepts various user inputs (user operations) such as an image quality adjustment instruction, an input switching instruction, and a calibration instruction.

The calibration unit 302 performs calibration. In performing the calibration, the calibration unit 302 provides a vibration execution instruction, a patch display instruction, and the like. In the calibration, for example, a patch image is displayed on a screen, and the display brightness and display colors of the patch image (brightness and colors on a screen) are measured using an optical sensor. Then, based on the results of the measurement, the calibration unit 302 adjusts the display characteristics (for example, the correspondence between image data and the value of a driving signal that drives a display element) of the display unit 306. Thus, the image quality (display brightness and display colors) of the display image is adjusted. The display image is an image displayed on the screen.

The vibration unit 303 is a vibrating vibration element. The vibration unit 303 is provided such that the display unit 306 is vibrated by vibration of the vibration unit 303. The vibration unit 303 is, for example, a motor that rotates around a position shifted from the center of gravity of the vibration unit 303. When a voltage is applied to the motor, the motor generates vibration. The vibration unit 303 starts vibration in response to a vibration start instruction from the vibration control unit 304 and ends the vibration in response to a vibration end instruction from the vibration control unit 304.

When the calibration unit 302 performs the calibration, the vibration control unit 304 vibrates the vibration unit 303. Specifically, before starting the calibration, the calibration unit 302 gives a vibration execution instruction (an instruction to execute a vibration process) to the vibration unit 303. Then, the vibration control unit 304 gives a vibration start instruction (an instruction to start a vibration process) to the vibration unit 303 in response to the vibration execution instruction. Thus, the vibration process is automatically executed before the calibration is started.

The image input/output control unit 305 outputs image data to the display unit 306. For example, the image input/output control unit 305 outputs data input from outside, image data acquired from a storage unit (not depicted in the drawings) of the display apparatus, or the like to the display unit 306 in accordance with the user's operation. Moreover, the calibration unit 302 gives a patch display instruction (an instruction to display a patch image) to the image input/output control unit 305 when executing the calibration. Then, in response to the patch display instruction, the image input/output control unit 305 generates image data that allows the patch image to be displayed and outputs the generated image data to the display unit 306. For example, image data representing the image being displayed is synthesized with image data representing the patch image to generate synthesized image data with the patch image superimposed on the image being displayed. The synthesized image data is then output.

The display unit 306 is a display panel that displays image data input to the display unit 306. Thus, when the calibration unit 302 performs the calibration, the display unit 306 displays a patch image (an image including the patch image).

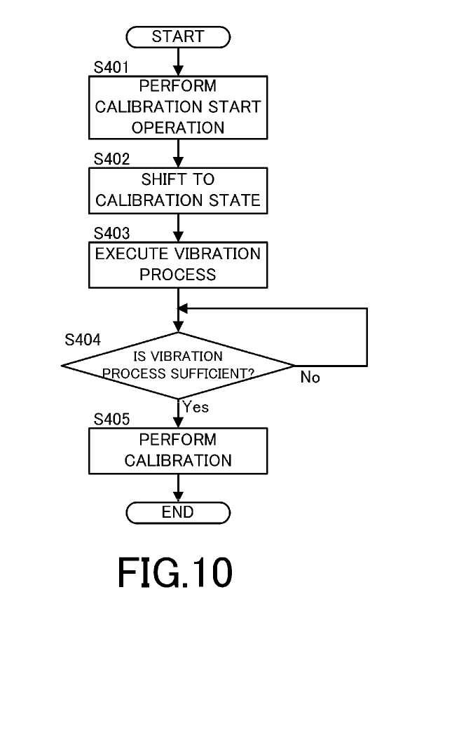

An operation of the display apparatus according to the third embodiment (the operation preformed when the calibration is executed) will be described using a flowchart in FIG. 10.

First, when the user performs an operation for starting the calibration, the UI control unit 301 transmits a calibration execution instruction to the calibration unit 302 (S401).

Then, upon receiving the calibration execution instruction, the calibration unit 302 shifts the state of the display apparatus to a calibration state (S402).

Then, the calibration unit 302 transmits a vibration execution instruction to the vibration control unit 304 (S403). At this time, in response to the reception of the vibration execution instruction, the vibration control unit 304 transmits a vibration start instruction to the vibration unit 303. In accordance with the vibration start instruction, the vibration unit 303 starts a vibration process.

Then, the vibration control unit 304 determines whether or not the vibration process has been sufficiently executed (S404). For example, the vibration control unit 304 determines whether or not a predetermined time has elapsed since the transmission of the vibration start instruction. Then, when the predetermined time has elapsed since the transmission of the vibration start instruction, the vibration control unit 304 determines that the vibration process has been sufficiently executed. When the predetermined time has not elapsed since the transmission of the vibration start instruction, the vibration control unit 304 determines that the vibration process has not been sufficiently executed.

The process in S404 is repeated until the vibration control unit 304 determines that the vibration process has been sufficiently executed. Upon determining that the vibration process has been sufficiently executed, the vibration control unit 304 transmits a vibration end instruction indicative of the end of the vibration process to the vibration unit 303 and transmits a notification of vibration process completion to the calibration unit 302. The process then proceeds to S405.

In S405, the vibration unit 303 ends the vibration process in accordance with the vibration end instruction, and the calibration unit 302 starts the calibration in accordance with the notification of vibration process completion. Thus, the calibration is started after the vibration process ends.

As described above, according to the third embodiment, the vibration process is automatically executed when the calibration is performed. Specifically, the vibration process is automatically executed before the calibration is started. This eliminates the need for the user to give an instruction to execute the vibration process each time the calibration is performed, improving the convenience of the display apparatus. Then, after the calibration, a display operation can be reliably performed with possible display unevenness caused by deformation of the optical element reduced.

### Fourth Embodiment

A display apparatus and a method for controlling the display apparatus according to a fourth embodiment will be described below. In the example described in the third embodiment, the vibration process is executed before the calibration is started. According to the fourth embodiment, an example will be described in which the vibration process is executed during a part of a period during which the calibration is performed.

The configuration of the display apparatus according to the fourth embodiment is the same as the configuration of the display apparatus according to the third embodiment (FIG. 9). Thus, description of the configuration is omitted.

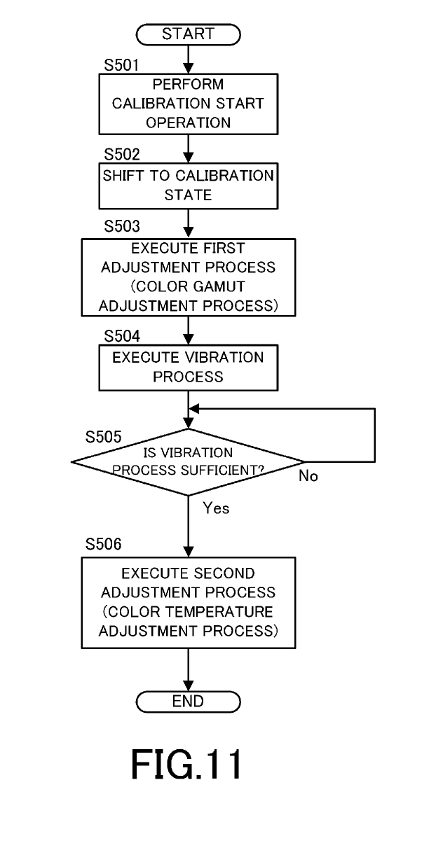

An operation of the display apparatus according to the fourth embodiment (the operation preformed when the calibration is executed) will be described using a flowchart in FIG. 11.

The fourth embodiment assumes that the calibration involves a plurality of adjustment processes executed in sequence.

The adjustment process is a process of adjusting at least one of, for example, color gamut, color temperature, gradation property and brightness. Thus, the adjustment process may be a process of adjusting only one or a plurality of the color gamut, the color temperature, the gradation property, or the brightness. For example, the adjustment process may be a process of adjusting only the color gamut or both the color gamut and the color temperature.

First, when the user performs an operation for starting the calibration, a UI control unit 301 transmits a calibration execution instruction to a calibration unit 302 (S501).

Then, upon receiving the calibration execution instruction, the calibration unit 302 shifts the state of the display apparatus to a calibration state (S502).

Then, the calibration unit 302 executes a first adjustment process (C503). In the fourth embodiment, a color gamut adjustment process is executed as the first adjustment process.

When the color gamut adjustment process in S503 is complete, the calibration unit 302 transmits a vibration execution instruction to a vibration control unit 304 (S504). At this time, in response to the reception of the vibration execution instruction, the vibration control unit 304 transmits a vibration start instruction to the vibration unit 303. In accordance with the vibration start instruction, the vibration unit 303 starts a vibration process.

Then, the vibration control unit 304 determines whether or not the vibration process has been sufficiently executed (S505). The process in S505 is repeated until the vibration process is determined to have been sufficiently executed. Upon determining that the vibration process has been sufficiently executed, the vibration control unit 304 transmits a vibration end instruction indicative of the end of the vibration process to the vibration unit 303 and transmits a notification of vibration process completion to the calibration unit 302. The process then proceeds to S506.

In S506, the vibration unit 303 ends the vibration process in accordance with the vibration end instruction, and the calibration unit 302 starts a second adjustment process in accordance with the notification of vibration process completion. Thus, the second adjustment process is started after the vibration process ends. That is, after the calibration is interrupted and the vibration process is then executed, the calibration is resumed. In the fourth embodiment, a color temperature adjustment process is executed as the second adjustment process.

As described above, according to the fourth embodiment, the vibration process is automatically executed when the calibration is performed. Specifically, the vibration process is automatically executed between the first adjustment process and the second adjustment process, which is performed following the first adjustment process. This eliminates the need for the user to give an instruction to execute the vibration process each time the calibration is performed, improving the convenience of the display apparatus. Then, after the calibration, a display operation can be reliably performed with possible display unevenness caused by deformation of the optical element reduced.

In the fourth embodiment, the example has been described in which the vibration process is started after the completion of the first adjustment process and in which the second adjustment process is started after the completion of the vibration process. However, the fourth embodiment is not limited to the example. For example, during a certain period, both the vibration process and the adjustment process may be executed in parallel. However, vibration of the optical element may reduce the accuracy of the adjustment process, and thus, the vibration process and the adjustment process are preferably not executed in parallel.

In the fourth embodiment, the example has been described in which the calibration involves the first adjustment process and the second adjustment process executed in sequence. However, the adjustment processes are not limited to the example. For example, the calibration may involve three or more adjustment processes executed in sequence.

Furthermore, in the fourth embodiment, the example has been described in which the first adjustment process is executed first, whereas the second adjustment process is executed last. However, the first adjustment process and the second adjustment process are not limited to the example. For example, if four or more adjustment processes are executed in sequence, the first adjustment process may be executed second, and the second adjustment process may be executed third.

Additionally, in the fourth embodiment, the example has been described in which the first adjustment process is the color gamut adjustment process, whereas the second adjustment process is the color temperature adjustment process. However, the first adjustment process and the second adjustment process are not limited to the example. As described above, first adjustment process and the second adjustment process may each be a process of adjusting at least one of, for example, the color gamut, the color temperature, the gradation property and the brightness.

In addition, in the fourth embodiment, the example has been described in which the color temperature adjustment process follows the color gamut adjustment process. However, the execution order of the adjustment processes is not limited to the example. For example, the color gamut adjustment process may follow the color temperature adjustment process or another adjustment process may be executed between the color gamut adjustment process and the color temperature adjustment process.

### Fifth Embodiment

A display apparatus and a method for controlling the display apparatus according to a fifth embodiment will be described below. In the fifth embodiment, a configuration will be described in which a vibration process may be omitted when calibration is performed.

The configuration of the display apparatus according to the fifth embodiment is the same as the configuration of the display apparatus according to the third embodiment (FIG. 9). Thus, description of the configuration is omitted.

The display apparatus according to the fifth embodiment has a plurality of operation modes including a normal calibration mode and a short-time calibration mode. When the normal calibration is set, the display apparatus according to the fifth embodiment performs the normal calibration in which a vibration process is executed when calibration is performed. On the other hand, when the short-time calibration is executed, the display apparatus according to the fifth embodiment performs the short-time calibration in which the vibration process is omitted when the calibration is performed. The short-time calibration mode is an operation mode in which the calibration is completed in a short time.

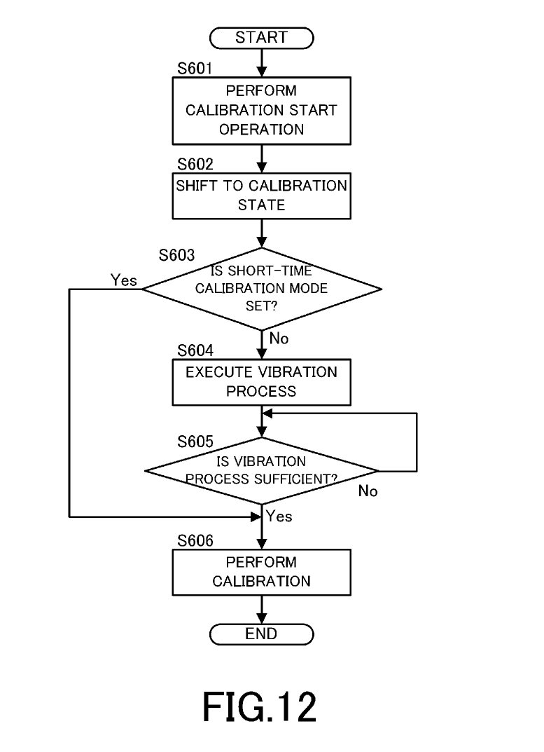

An operation of the display apparatus according to the fifth embodiment (the operation preformed when the calibration is executed) will be described using a flowchart in FIG. 12. For simplification, an example will be described in which, as calibration, either the normal calibration or the shot-time calibration is performed. However, the calibration is not limited to these two types. The display apparatus may have an operation mode in which a calibration operation different from the normal calibration and the short-time calibration is performed.

First, a UI control unit 301 prompts the user to select the operation mode and sets the operation mode selected by the user. Specifically, the UI control unit 301 prompts the user to select either the normal calibration mode or the short-time calibration mode and sets the calibration mode selected by the user in a calibration unit 302. More specifically, when the user performs an operation of starting the calibration, the UI control unit 301 transmits a calibration execution instruction to the calibration unit 302 (S601).

Then, upon receiving the calibration execution instruction, the calibration unit 302 shifts the state of the display apparatus to a calibration state (S602).

Then, the calibration unit 302 determines whether the normal calibration mode or the short-time calibration mode is set (S603). That is, the calibration unit 302 determines whether a user operation of starting the normal calibration mode or a user operation of starting the short-time calibration mode has been performed in S601.

When the normal calibration mode is set, that is, when the user operation of starting the normal calibration mode is performed in S601, the process proceeds to S604.

When the short-time calibration mode is set, that is, when the user operation of starting the short-time calibration mode is performed in S601, the process proceeds to S606.

In S604, the calibration unit 302 transmits a vibration execution instruction to a vibration control unit 304. At this time, in response to the reception of the vibration execution instruction, the vibration control unit 304 transmits a vibration start instruction to a vibration unit 303. In accordance with the vibration start instruction, the vibration unit 303 starts a vibration process.

Then, the vibration control unit 304 determines whether or not the vibration process has been sufficiently executed (S605). For example, the vibration control unit 304 determines whether or not a predetermined time has elapsed since the transmission of the vibration start instruction. Then, when the predetermined time has elapsed since the transmission of the vibration start instruction, the vibration control unit 304 determines that the vibration process has been sufficiently executed. When the predetermined time has not elapsed since the transmission of the vibration start instruction, the vibration control unit 304 determines that the vibration process has not been sufficiently executed.

The process in S605 is repeated until the vibration control unit 304 determines that the vibration process has been sufficiently executed. Upon determining that the vibration process has been sufficiently executed, the vibration control unit 304 transmits a vibration end instruction indicative of the end of the vibration process to the vibration unit 303 and transmits a notification of vibration process completion to the calibration unit 302. The process then proceeds to S606.

If the normal calibration mode is set, then in S605, the vibration unit 303 ends the vibration process in accordance with the vibration end instruction, and the calibration unit 302 starts the calibration in accordance with the notification of vibration process completion. Thus, the calibration is started after the vibration process ends.

If the short-time calibration mode is set, then in S605, the calibration unit 302 starts the calibration in accordance with the notification of vibration process completion. Thus, the calibration is performed with the vibration process omitted.

As described above, according to the fifth embodiment, if the normal calibration mode is set, the vibration process is automatically executed when the calibration is performed. This allows effects similar to the effects of the third and fourth embodiments to be exerted. Furthermore, if the short-time calibration mode is set, the vibration process is omitted when the calibration is performed. This enables a reduction in the execution time of the calibration.

In the fifth embodiment, the example has been described in which the user selects the operation mode and in which the operation mode selected by the user is set. However, the method for setting the operation mode is not limited to the example. For example, the operation mode may be automatically set in accordance with the type of image data. Specifically, the operation mode may be automatically set so that the short-time calibration mode is set in order to display text data, whereas the normal calibration mode is set in order to display electrophotographic data or illustration data.

In the fifth embodiment, the example has been described in which the function to switch between the execution and non-execution of the vibration process depending on the operation mode is added to the configuration of the third embodiment. However, such a function may be added to the configuration of the fourth embodiment.

### Variation

The description of the embodiments is illustrative for the description of the present invention. The embodiments may be appropriately changed or combined together without departing from the spirits of the invention.

For example, the present invention may be implemented as a display apparatus including at least some of the above-described processes. Furthermore, the present invention may be implemented as a method for controlling the display apparatus which method includes at least some of the above-described processes. The above-described processes and units may be freely combined together for implementation provided that the combination leads to no technical inconsistency.

Furthermore, the description of the first and second embodiments illustrates the acceleration sensor, contact sensor, and switch as means for detecting movement of the display apparatus and illustrates the turn detection switch as means for detecting turn of the display panel. However, other means may be used. Alternately, the means may be combined together. For example, a well-known sensor or switch may be adopted provided that the sensor or switch can detect movement and turn.

Additionally, in the embodiments, the liquid crystal display has been described by way of example. However, the present invention is applicable to a display apparatus with an organic EL display or any other display. The present invention is applicable to any display apparatus as long as the optical element such as the display panel is deformed by stress.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-230437, filed on Nov. 6, 2013, and Japanese Patent Application No. 2013-239112, filed on Nov. 19, 2013, which are hereby incorporated by reference herein in their entirety.

What is claimed is:

1. A display apparatus comprising:
a display panel;
a vibration element configured to vibrate the display panel;
a detection unit configured to detect movement of the display apparatus or turn of the display panel; and
a correction unit configured to vibrate the vibration element in a case where the detection unit detects the movement of the display apparatus or the turn of the display panel.

2. The display apparatus according to claim 1, wherein the detection unit includes a unit configured to detect whether or not the display apparatus is grounded, and determines that the display apparatus has been moved based on a result of the detection.

3. The display apparatus according to claim 1, wherein the detection unit includes a sensor configured to detect acceleration, and determines that the display apparatus has been moved or the display panel has been turned based on the detected acceleration.

4. The display apparatus according to claim 1, wherein the detection unit includes a sensor configured to detect inclination, and determines that the display apparatus has been moved or the display panel has been turned based on the detected inclination.

5. The display apparatus according to claim 1, wherein the vibration element is an element configured to be able to adjust an amount of vibration, and
the correction unit determines the amount of vibration of the vibration element based on an output from the detection unit.

6. The display apparatus according to claim 1, wherein the correction unit further includes a storage unit configured to store whether or not the display apparatus has been moved or the display panel has been turned, and upon determining that the display apparatus has been moved or the display panel has been turned, vibrates the vibration element at a timing in a case where the display panel is energized.

7. A method for controlling a display apparatus including a display panel, a vibration element configured to vibrate the display panel, and a detection unit configured to detect movement of the display apparatus or turn of the display panel,
the method comprising:
a determination step of determining whether the display apparatus has been moved or the display panel has been turned based on an output from the detection unit; and
a correction step of vibrating the vibration element in a case where the display apparatus is determined to have been moved or the display panel is determined to have been turned.

8. The method for controlling a display apparatus according to claim 7, wherein the detection unit is a unit configured to detect whether or not the display apparatus is grounded, and
the determination step includes determining that the display apparatus has been moved based on an output from of the detection unit.

9. The method for controlling a display apparatus according to claim 7, wherein the detection unit is a sensor configured to detect acceleration, and
the determination step includes determining that the display apparatus has been moved or the display panel has been turned based on the acceleration detected by the detection unit.

10. The method for controlling a display apparatus according to claim 7, wherein the detection unit is a sensor configured to detect inclination, and
the determination step includes determining that the display apparatus has been moved or the display panel has been turned based on the inclination detected by the detection unit.

11. The method for controlling a display apparatus according to claim 9, wherein the vibration element is an element configured to be able to adjust an amount of vibration, and
the correction step includes determining the amount of vibration of the vibration element based on an output from the detection unit.

12. The method for controlling a display apparatus according to claim 7, wherein the determination step includes storing whether or not the display apparatus has been moved or the display panel has been turned, and
the correction step includes, upon determining that the display apparatus has been moved or the display panel has been turned, vibrating the vibration element at a timing in a case where the display panel is energized.

13. A display apparatus capable of performing calibration, comprising:
a plate-like optical element;
a vibration element; and
a control unit configured to vibrate the vibration element to vibrate the optical element in a case where the calibration is performed.

14. The display apparatus according to claim 13, wherein the optical element includes at least one of a display panel, a glass substrate and a polarizer.

15. The display apparatus according to claim 13, wherein the control unit vibrates the vibration element before the calibration is started.

16. The display apparatus according to claim 13, wherein the control unit vibrates the vibration element during a part of a period during which the calibration is performed.

17. The display apparatus according to claim 13, wherein the calibration includes a plurality of adjustment processes executed in sequence, and
the control unit executes a process of vibrating the vibration element between a first adjustment process and a second adjustment process that is performed following the first adjustment process.

18. The display apparatus according to claim 17, wherein the adjustment process is a process of adjusting at least one of color gamut, color temperature, gradation property and brightness.

19. The display apparatus according to claim 13, comprising a plurality of operation modes including a short-time calibration mode, wherein
in a case where the short-time calibration mode is set, the control unit omits the process of vibrating the vibration element in a case where the calibration is performed.

20. The display apparatus according to claim 19, further comprising a setting unit configured to set an operation mode selected by a user.

21. A method for controlling a display apparatus including a plate-like optical element and a vibration element,
the method comprising:
an execution step of calibrating the display apparatus; and
a control step of vibrating the vibration element to vibrate the optical element in a case where the calibration is performed.

22. The method for controlling a display apparatus according to claim 21, wherein the optical element includes at least one of a display panel, a glass substrate and a polarizer.

23. The method for controlling a display apparatus according to claim 21, wherein the control step includes vibrating the vibration element before the calibration is started.

24. The method for controlling a display apparatus according to claim 21, wherein the control step includes vibrating the vibration element during a part of a period during which the calibration is performed.

25. The method for controlling a display apparatus according to claim 24, wherein the calibration includes a plurality of adjustment processes executed in sequence, and
the control step includes executing a process of vibrating the vibration element between a first adjustment process and a second adjustment process that is performed following the first adjustment process.

26. The method for controlling a display apparatus according to claim 25, wherein the adjustment process is a process of adjusting at least one of color gamut, color temperature, gradation property and brightness.

27. The method for controlling a display apparatus according to claim 21, wherein the display apparatus has a plurality of operation modes including a short-time calibration mode, and
the control step includes omitting the process of vibrating the vibration element in a case where the calibration is performed in a case where the short-time calibration mode is set.

28. The method for controlling a display apparatus according to claim 27, further comprising a setting step of prompting a user to select an operation mode and setting the operation mode selected by the user.

29. A non-transitory computer readable medium recording a computer program for causing a computer to perform the method according to claim 7.

30. A non-transitory computer readable medium recording a computer program for causing a computer to perform the method according to claim 21.
